(19) United States
(12) Patent Application Publication
(10) Pub. No.: US 2007/0153051 A1
(43) Pub. Date: Jul. 5, 2007

(54) Manufacturing flat panel displays with inkjet printing systems

(75) Inventor: Dong-Won Lee, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd., Suwon-si (KR)

(21) Appl. No.: 11/544,340

(22) Filed: Oct. 5, 2006

(30) Foreign Application Priority Data
Jan. 5, 2006 (KR) 10-2006-0001233

(51) Int. Cl. B41J 23/00

(52) U.S. Cl. 347/37

(57) ABSTRACT

An inkjet printing system for manufacturing displays includes a stage on which a substrate is mounted, an inkjet head for depositing ink on the substrate, and a transfer device for controllably moving the inkjet head to selected positions above the substrate. The inkjet head includes a frame having a plurality of openings and a plurality of single heads that are readily attachable to and detachable from respective ones of the openings. Since the inkjet head includes a plurality of attachable and detachable single heads, if one nozzle of the inkjet head is damaged or becomes dysfunctional, the system can be repaired by replacing only one of the single heads, without the need to replace the entire inkjet head. As a result, the maintenance costs of the inkjet printing system are reduced.

### RELATED APPLICATIONS

This application claims priority of Korean Patent Application No. 10-2006-0001233, filed Jan. 5, 2006, the entire contents of which are incorporated herein by reference.

### BACKGROUND

This invention relates to an inkjet printing system and methods for its use in manufacturing flat panel displays, such as liquid crystal displays (LCDs) and organic light emitting diode (OLED) displays.

During the manufacture of certain flat panel display devices, such as LCDs or OLED displays, various thin film patterns are formed on panel substrates of the devices, typically using photolithography processes. However, as displays become larger, the amount of material, such as a photosensitive film, that must be deposited on substrates to form the thin film patterns also becomes larger, and as a result, the manufacturing costs of the panels increase and the manufacturing equipment for the photolithography processes becomes larger and more expensive.

In an effort to minimize such problems, inkjet printing systems have been developed for forming the thin film patterns on the substrates by depositing them on the substrates in the form of special inks. These systems deposit the ink on the substrate through an inkjet head. However, the inkjet head includes a plurality of nozzles, and if only one of these nozzles becomes dysfunctional, the number of passes that the inkjet printing head must make increases. For example, if the inkjet head has one hundred nozzles, and the sixtieth nozzle is damaged, only the first to fifty-ninth nozzles and the sixty-first to hundredth nozzles are available, and thus, in order to deposit ink over entire target region of the substrate, the inkjet head must be moved, or offset, by a selected interval so as to deposit ink on the region corresponding to the sixtieth nozzle. As a result, processing time and costs are substantially increased.

Additionally, since all of the nozzles of the inkjet head must be kept in good operating condition, downtime increases and process stability margins deteriorate.

### BRIEF SUMMARY

In accordance with the particular exemplary embodiments thereof described herein, the present invention provides inkjet printing systems and methods for their use in manufacturing flat panel display devices that are more stable and reliable than the inkjet printing systems of the prior art.

In one exemplary embodiment thereof, an inkjet printing system for manufacturing a flat panel display device includes a stage on which a substrate of the panel is mounted, an inkjet head operable to selectively deposit ink on the substrate, and a transfer device operable to controllably move the inkjet head to selected positions over the substrate. The inkjet head includes a frame having a plurality of openings therein and a plurality of single heads that are easily attachable to and detachable from the openings.

At least one nozzle is formed in each single head, and the frame is formed in a matrix shape. A plurality of reserve single heads may also be provided in one column or row of the plurality of openings.

The substrate may comprise a substrate of an LCD or an OLED display, and the ink may be an ink adapted to form a color filter or an organic light emitting member on the substrate. A partitioning wall member that encloses the deposited ink may also be formed on the substrate, and the partitioning wall member may comprise a light blocking member of an LCD or a partitioning wall of an OLED display.

An exemplary embodiment of a method for manufacturing a flat panel display device in accordance with the present invention includes positioning an inkjet head over a substrate of the display, the inkjet head including a frame having a plurality of openings and a plurality of single heads that are attachable to and detachable from the openings, depositing ink on the substrate through nozzles of the single heads of the inkjet head, and if a dysfunctional nozzle is detected in one of the single heads, replacing the single head with the dysfunctional nozzle.

In another exemplary embodiment of the invention, a method for manufacturing a flat panel display device includes positioning an inkjet head over a substrate of the display, the inkjet head including a frame having a plurality of openings and a plurality of single heads and a plurality of reserve single heads that are attachable to and detachable from the openings, depositing ink on the substrate through nozzles of the single heads of the inkjet head, and if a dysfunctional nozzle is detected in one of the single heads, stopping the operation of the single head with the dysfunctional nozzle and operating a reserve single head in place of the single head with the dysfunctional nozzle.

At least one nozzle may be formed in each single head, and the frame may be formed in a matrix shape. The plurality of reserve single heads may be provided in a column or a row of the plurality of openings.

The substrate may be a substrate for an LCD or an OLED display, and the ink may be an ink that is adapted to form a color filter or an organic light emitting member on the substrate. A partitioning wall member for enclosing the deposited ink may be formed on the substrate, and the partitioning wall member may be a light blocking member of an LCD or a partitioning wall of an OLED display.

A better understanding of the above and many other features and advantages of the inkjet printing systems and the methods for their use in manufacturing flat panel display devices of the invention may be obtained from a consideration of the detailed description of some exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is an upper front perspective view of an exemplary embodiment of an inkjet printing system for manufacturing flat panel displays in accordance with the present invention;

FIG. 2 is a bottom plan view of an inkjet head and a transfer device of the exemplary inkjet printing system of FIG. 1;

FIG. 3 is an upper side perspective view of the inkjet head, showing a single nozzle of the head exploded upward from the head;

FIG. 4A and FIG. 4B are bottom plan views of alternative embodiments of inkjet heads of the exemplary inkjet printing system;

FIG. 5 is a schematic representation illustrating an exemplary embodiment of a method of printing ink on a substrate of a flat panel display using an exemplary embodiment of an inkjet head of an exemplary embodiment of inkjet printing system in accordance with the present invention;

FIG. 6 is a side elevation view, partially in cross-section, of a display substrate upon which ink is being deposited using an exemplary embodiment of an inkjet printing system of the present invention to form a color filter;

FIG. 7 is a partial plan view of an exemplary embodiment of an LCD panel manufactured by an exemplary embodiment of inkjet printing system in accordance with the present invention, showing a single pixel region thereof;

FIG. 8 is a cross-sectional view of the exemplary LCD panel of FIG. 7, as seen along the section lines VIII-VIII taken therein;

FIG. 9 is a schematic circuit diagram of an exemplary embodiment of an OLED display panel in accordance with the present invention;

FIG. 10 is a partial plan view of an exemplary embodiment of an OLED display panel manufactured by an exemplary embodiment of an inkjet printing system in accordance with the present invention; and,

FIG. 11 is a cross-sectional view of the exemplary OLED panel of FIG. 10, as seen along the section lines XI-XI taken therein.

### DETAILED DESCRIPTION

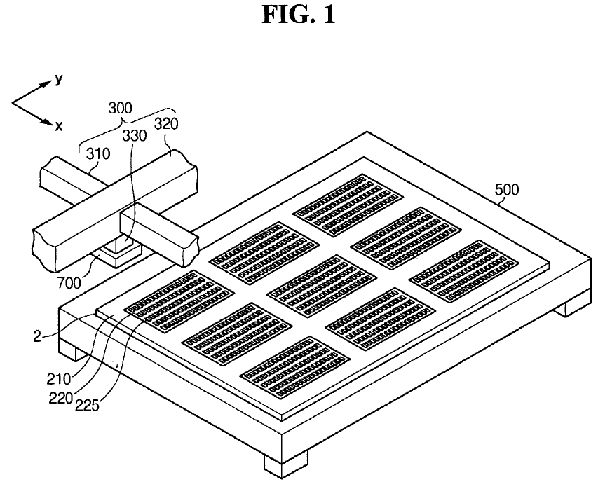

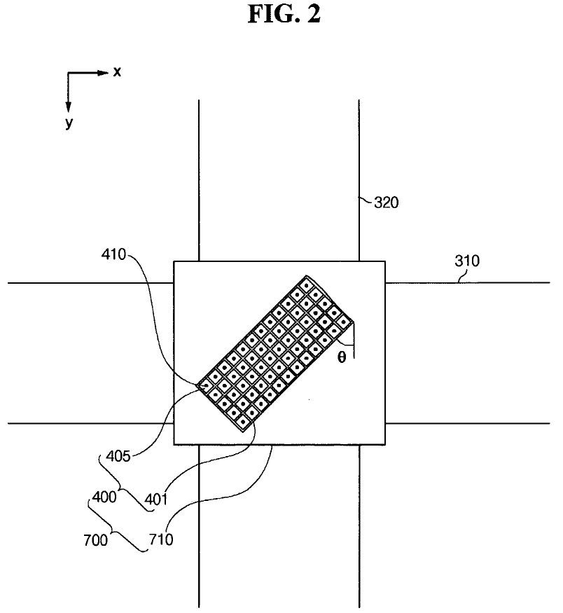

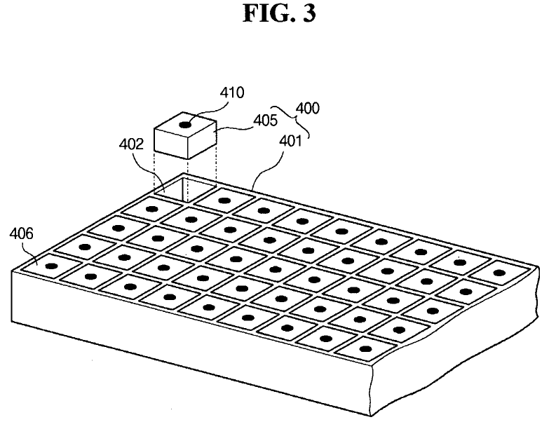

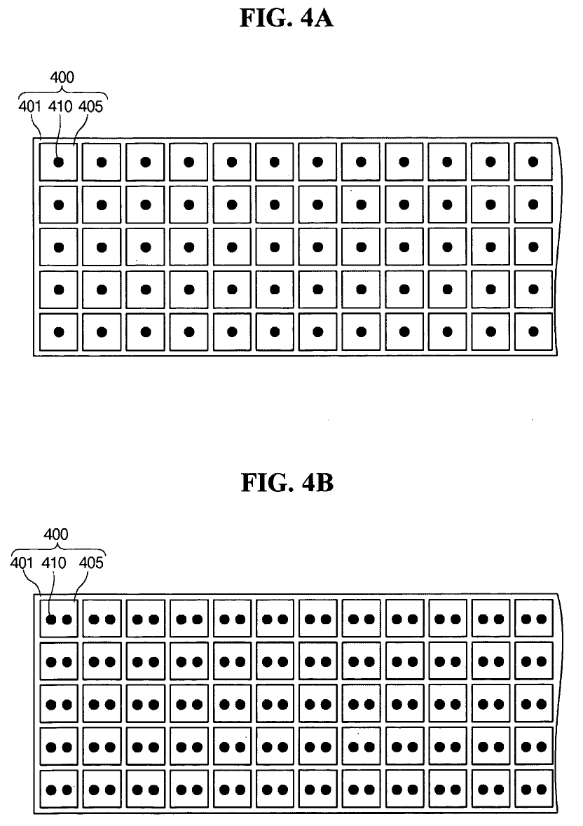

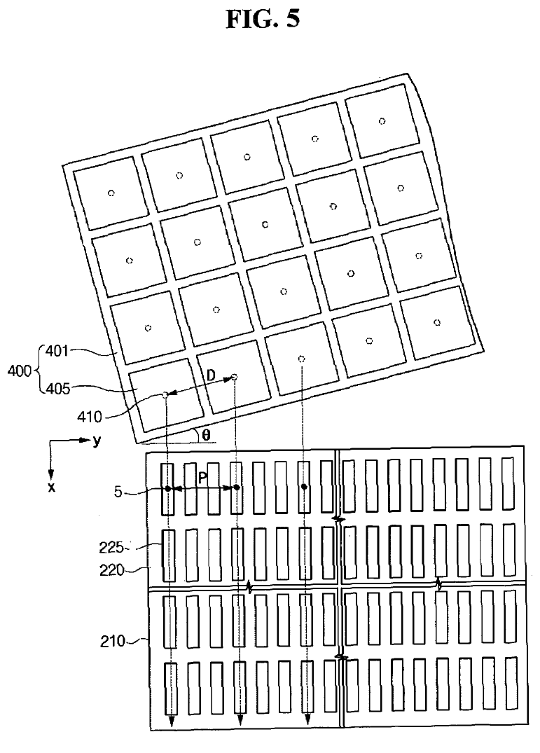

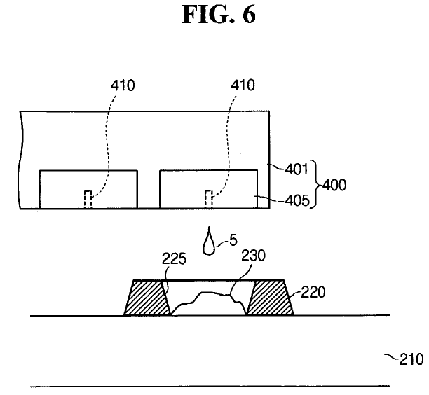

FIG. 1 is an upper front perspective view of an exemplary embodiment of an inkjet printing system for manufacturing flat panel displays in accordance with the present invention, FIG. 2 is a bottom plan view of an inkjet head and a transfer device of the exemplary inkjet printing system of FIG. 1, FIG. 3 is an upper side perspective view of the exemplary inkjet head, with a single nozzle of the head shown exploded upward from the head, FIGS. 4A and 4B are bottom plan views of alternative embodiments of inkjet heads of the exemplary inkjet printing system, FIG. 5 is a schematic representation of an exemplary embodiment of a method of printing ink on a substrate of a flat panel display using the exemplary inkjet head of the exemplary system, and FIG. 6 is a side elevation view, partially in cross-section, of a display substrate upon which ink is being deposited using the exemplary system to form a color filter thereon.

As illustrated in FIGS. 1-6, an exemplary embodiment of the inkjet printing system includes a stage 500 on which a “mother” substrate 2 is mounted, a head unit 700 spaced a selected distance above the stage 500, and a transfer device 300 operable to move the head unit 700 to selected positions over the mother substrate 2.

The stage 500 is preferably made larger than and functions to support the mother substrate 2 below the inkjet head, and the mother substrate 2 includes a plurality of individual display substrates 210 that are each used to form a portion of a color filter array panel of an LCD, a thin film transistor (TFT) array panel of an OLED display, or the like.

In the particular exemplary embodiment of FIG. 1, a mother substrate 2 used for forming the color filter array panels 210 of an LCD is illustrated, and each of the individual LCD substrates 710 includes a respective light blocking member 220 having a plurality of openings 225 formed therein.

As illustrated in FIG. 2, the head unit 700 includes an inkjet head 400 and a connecting member 710 that attaches the inkjet head 400 to the transfer device 300. The inkjet head 400 is formed in the shape of a rectangular matrix, and includes a frame 401 having a plurality of openings 402 and a plurality of single heads 405 fitted into respective ones of the openings 402 of the frame 401. The single heads 405 are attachable to and detachable from the frame 401. A plurality of the single heads 405 disposed in a single column or row of the inkjet head 400 comprise reserve single heads 406 (see FIG. 3). Each single head 405 includes at least one nozzle 410. FIG. 4A shows an exemplary embodiment in which only one nozzle 410 is formed in a single head 405, and FIG. 4B shows an alternative exemplary embodiment in which two nozzles 410 are formed in a single head 405. The inkjet printing system is operable to selectably spray different types of inks 5 onto the substrate 2 through the nozzles 410 to form desired thin film ink structures thereon, as described in more detail below.

In the exemplary embodiments illustrated in FIGS. 1-6, longitudinal and transverse directions relative to the mother substrate 2 are indicated by the orthogonal Y and X axes, respectively, as shown in, e.g., FIGS. 1, 2 and 5, and as illustrated in FIGS. 2 and 5, the inkjet head 400 is oriented at a selected angle θ with respect to the Y direction. That is, since the pitch D of the nozzles 410, i.e., the distance between the nozzles 410 disposed in neighboring single heads 405, is different from the pitch P of the pixels on the respective substrates 210, i.e., the distance between the pixel features that will be printed thereon, the interval between deposited inks 5 is conformed to the pixel pitch P by rotating the inkjet head 400 to the selected angle θ.

The transfer device 300 includes a Y-direction transfer member 310 for programmably positioning the head unit 700 a selected distance above the substrate 210 and for transferring the head unit 700 in the Y direction, an X-direction transfer member 320 for transferring the head unit 700 in the X direction, and a Z-direction transfer, or lifter member 330, for raising and lowering the head unit 700 relative to the substrate and in a direction perpendicular to the X and Y directions.

In one particular exemplary embodiment of the present invention, since the inkjet head 400 includes a plurality of attachable and detachable single heads 405, in the event that one of the nozzles 410 of the inkjet head 400 becomes damaged or otherwise dysfunctional, a repair can be effected by simply replacing only the single dysfunctional head 405, instead of replacing the entire inkjet head 400, thereby reducing the maintenance costs of the inkjet printing system.

Additionally, since a plurality of reserve single heads 406 are provided in the inkjet head 400 in advance, when a nozzle 410 of a single head 405 is damaged or otherwise becomes dysfunctional, it can be replaced immediately by one of the reserve single heads 406, so that the available running time of the inkjet printing system can be increased, thereby enhancing reliability.

In addition, since one inkjet head 400 is provided with a plurality of single heads 405, the pitch P between the nozzles 410 can be readily adjusted to be relatively short, so that the pitch P between the ink deposits and the spray time required for their formation can be easily and precisely regulated, thereby enabling various advantageous process changes to be made, as described in more detail below.

A exemplary embodiment of a method for forming a color filter on the display substrates 210 using the exemplary inkjet printing system described above is described below in conjunction with FIGS. 1-6.

First, the head unit 700 is selectably positioned above a selected one of the individual substrates 210 by the operation of the X-direction and Y-direction transfer members 320 and 310 and the lifter member 330 of the transfer device 300 of the inkjet printing system.

Next, as illustrated in FIG. 6, by driving the X-direction transfer member 320 of the transfer device 300 while simultaneously forcing ink 5 through the nozzles 410 of the single heads 405 of the inkjet head 400, the ink 5 is deposited on the substrate while the head unit 700 moves in the X direction, thereby forming a color filter 230 in each of the pixels of the substrate.

Subsequently, if it is discovered that one of the nozzles 410 has become dysfunctional, either the single head 405 with the dysfunctional nozzle is replaced, or the operation of the single head with the dysfunctional nozzle is suspended and the redundant reserve single head 406 is operated in its place.

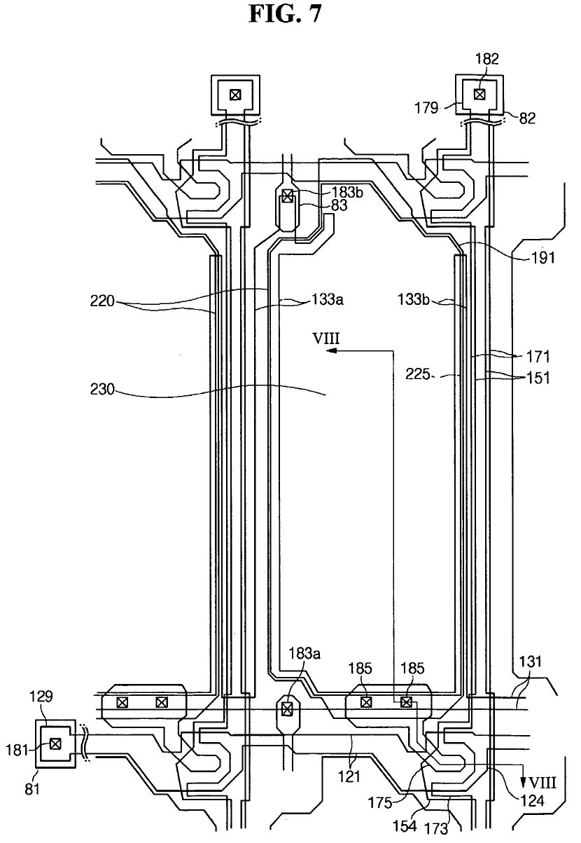

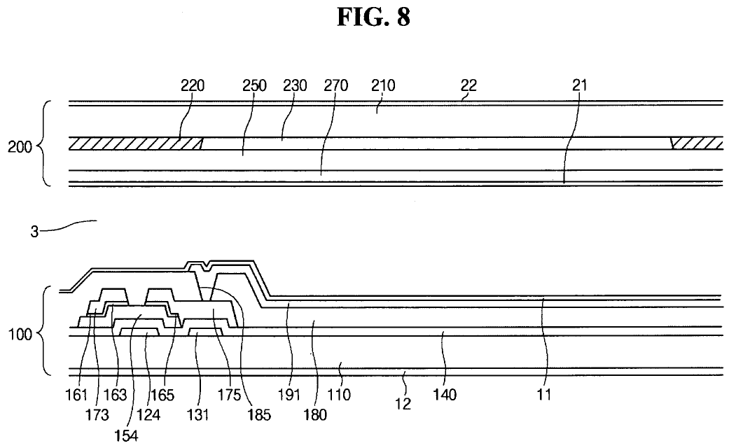

The display panels that can be formed by the exemplary inkjet printing system of the present invention can include, for example, a color filter array panel of an LCD, or a TFT array panel of an OLED display. FIG. 7 is a partial plan view of an exemplary embodiment of an LCD panel manufactured by an exemplary embodiment of an inkjet printing system in accordance with the present invention, showing a single pixel region thereof, and FIG. 8 is a cross-sectional view of the exemplary LCD panel of FIG. 7, as seen along the section lines VIII-VIII therein.

As illustrated in FIGS. 7 and 8, the LCD panel includes a lower TFT array panel 100, an upper color filter array panel 200, and a layer of a liquid crystal material 3 disposed between the two panels 100 and 200.

Referring to FIGS. 7 and 8, the thin film transistor array panel 100 includes a plurality of gate lines 121 and a plurality of storage electrode lines 131 formed on an insulating substrate 110 made of a transparent material, such as glass, plastic, or the like. The gate lines 121 transmit gate signals and extend in a generally horizontal direction in FIG. 7. Each of the gate lines 121 includes a plurality of gate electrodes 124 that protrude downwardly and an enlarged end portion 129 that is adapted for connection to another layer or an external driving circuit (not illustrated). A selected voltage is applied to each storage electrode line 131, which includes a storage electrode line extending substantially parallel to the gate lines 121 and a plurality of pairs of first and second storage electrodes 133a and 133b branching outward therefrom. Each of the storage electrode lines 131 is disposed between two neighboring gate lines 121, and nearer to a lower one of the two gate lines 121.

A gate insulating layer 140, made of, e.g., silicon nitride (SiNx), silicon oxide (SiOx), or the like, is formed on the gate lines 121 and the storage electrode lines 131. A plurality of semiconductor stripes 151, made of, e.g., hydrogenated amorphous silicon (a-Si), polysilicon, or the like, are formed on the gate insulating layer 140. The semiconductor stripes 151 extend in a generally vertical direction in FIG. 7, and include a plurality of protrusions 154 that protrude toward the gate electrodes 124. The semiconductor stripes 151 are made wider near the gate lines 121 and the storage electrode lines 131 so as to overlap the latter.

A plurality of ohmic contact stripes and islands 161 and 165 are formed on each semiconductor stripe 151. The ohmic contacts 161 and 165 may comprise a material, such as n+ hydrogenated amorphous silicon, in which an n-type impurity, such as phosphor, is doped at a high concentration, or silicide. Each ohmic contact stripe 161 includes a plurality of protrusions 163, and one protrusion 163 and one of the ohmic contact islands 165 are disposed on the protrusions 154 of each semiconductor stripe 151 in associated pairs. A plurality of data lines 171 and a plurality of drain electrodes 175 are formed on the ohmic contacts 161 and 165 and the gate insulating layer 140.

Each of the data lines 171 transmits a respective data signal, and extend in a generally vertical direction in FIG. 7 so as to cross over the gate lines 121 orthogonally. Each of the data lines 171 also crosses over the storage electrode lines 131 and runs between neighboring sets of the storage electrodes 133a and 133b. Each of the data lines 171 includes a plurality of source electrodes 173 extending toward the gate electrodes 124 and an end portion 179 having a widened area adapted for connection to another layer or an external driving circuit.

The drain electrodes 175 are separated from the data lines 171 and are disposed opposite to the source electrodes 173 centering on the gate electrodes 124. Each of the drain electrodes 175 includes a wide end portion and an opposite bar-shaped end portion. The wide end portion overlies an associated storage electrode line 131, and the bar-shaped end portion is partially surrounded by an angulated source electrode 173.

One gate electrode 124, one source electrode 173, and one drain electrode 175, together with one protrusion 154 of a semiconductor stripe 151, form one thin film transistor TFT, and a channel of the thin film transistor is formed on the protrusion 154 between the source electrode 173 and the drain electrode 175.

The ohmic contacts 161 and 165 exist only between the semiconductor stripe 151 below and the data line 171 and the drain electrode 175 above, and function to lower the contact resistance therebetween.

A passivation layer 180 is formed on the data lines 171, the drain electrodes 175, the gate insulating layer 140, and the exposed portions of the semiconductor stripes 151. The passivation layer 180 may be made of, e.g., an inorganic insulator, an organic insulator, or the like, and may formed to have a flat surface.

A plurality of contact holes 182 and 185 respectively exposing end portions 179 of the data lines 171 and the drain electrodes 175 are formed in the passivation layer 180. Respective pluralities of contact holes 181 exposing the end portions 129 of the gate lines 121, contact holes 183a exposing portions of the storage electrode lines 131 near the fixed ends of the first storage electrodes 133a, and contact holes 183b exposing the protrusions of the free ends of the first storage electrodes 133a, are formed in the passivation layer 180 and the gate insulating layer 140.

Respective pluralities of pixel electrodes 191, overpasses 83, and contact assistants 81 and 82 are formed on the passivation layer 180. The pixel electrodes 191 are physically and electrically connected to the drain electrodes 175 through the contact holes 185, and respective data voltages are applied to the pixel electrodes 191 from the drain electrodes 175. When the respective data voltages are applied to the pixel electrodes 191, they, together with a common electrode 270 of the upper color filter array panel 200 to which a common voltage is applied, generate an electric field, and thereby determine the direction of orientation of the molecules of the liquid crystal layer 3 disposed between the two electrodes. The direction of polarization of the liquid crystal molecules in turn affects the polarization of the light passing through the molecules. Each of the pixel electrodes 191, together with the common electrode 270, forms a capacitor, referred to herein as a liquid crystal capacitor, which functions to maintain the voltage applied to the pixel electrodes even after the associated thin film transistor is turned off.

The pixel electrodes 191 and the drain electrodes 175 connected thereto overlie the storage electrodes 133a and 133b and the storage electrode lines 131. The pixel electrodes 191 and the drain electrodes 175 electrically connected thereto overlie the storage electrode lines 131, thereby forming another capacitor, referred to herein as a storage capacitor. Each of the storage capacitors functions to strengthen the voltage maintaining capacity of an associated one of the liquid crystal capacitors.

The contact assistants 81 and 82 are respectively connected to the end portions 129 of the gate lines 121 and the end portions 179 of the data lines 171 through the contact holes 181 and 182. The contact assistants 81 and 82 complement the adhesive property of the end portions 129 of the gate lines 121 and the end portions 179 of the data lines 171 to an external device, and also serve to protect these members.

The overpasses 83 cross the gate lines 121, and are connected to the exposed portions of the storage electrode lines 131 and the exposed end portions of the free ends of the storage electrodes 133a, respectively, through the contact holes 183a and 183b that are disposed opposite to each other, with the gate lines 121 interposed therebetween. The storage electrodes 133a and 133b and the storage electrode lines 131, together with the overpasses 83, can be used to repair faults in the gate lines 121, the data lines 171, or the thin film transistors.

The color filter array panel 200 of the exemplary LCD is described below with reference to FIG. 7 and FIG. 8.

A light blocking member 220 is formed on an insulating substrate 210 made of a transparent material, e.g., glass, plastic, or the like. The light blocking member 220 is also referred to as a black matrix, and functions to selectively block the leakage of light from the panel. The light blocking member 220 includes a plurality of openings 225 facing the pixel electrodes 191 and having substantially the same shape as the pixel electrodes 191, and blocks the leakage of light between the pixel electrodes 191. However, the light blocking member 220 can also include a portion corresponding to the gate lines 121 and the data lines 171 and a portion corresponding to the thin film transistors. As described in more detail below, the light blocking member 220 can also serve as a partitioning wall member for enclosing the ink of a color filter during the manufacture of a color filter array panel with the inkjet printing systems of the present invention.

A plurality of color filters 230 formed by the inkjet printing system are positioned in the openings 225 of the light blocking member 220. Most of the color filters 230 exist within a region surrounded by the light blocking member 220, and can extend along a column of the pixel electrodes 191. Each of the color filters 230 may produce light of one primary color, such as red, green, or blue.

An optional overcoat 250 can be formed on the color filters 230 and the light blocking member 220. The overcoat 250 can comprise, e.g., an organic insulating material. The overcoat 250 prevents the color filters 230 from being exposed and provides a planar surface. Alternatively, the overcoat 250 can be omitted.

The common electrode 270 is formed on the overcoat 250. The common electrode 270 is made of a transparent electrical conductor, such as ITO and IZO, or the like.

Alignment layers 11 and 21 are coated on inner surfaces of the display panels 100 and 200, and they can comprise a horizontal alignment layer or a vertical alignment layer. Polarizers 12 and 22 are respectively provided on outer surfaces of the display panels 100 and 200. The axes of polarization of the two polarizers 12 and 22 cross at right angles, and it is preferable that one of the polarization axes be made parallel with the gate lines 121. In the case of a reflective type of LCD, one of the two polarizers 12 and 22 can be omitted.

An exemplary embodiment of a method for manufacturing the color filter array panel illustrated in FIGS. 7 and 8 is described in detail below.

First, a metal layer, such as a layer of chromium, is formed on the insulating substrate 210, which can be made of a transparent glass or the like, by a vacuum deposition process or the like, and the light blocking member 220 with its plurality of openings 225 is formed by a photolithography process. The light blocking member 220 can be formed by depositing a high molecular resin solution, performing a spin coating, and then performing a photolithography process on the coating. The light blocking member 220 can also be formed by various other known methods.

Next, the color filters 230 are formed in the openings 225 of the light blocking member 200 using the inkjet printing system of the invention described above. That is, each opening 225 is filled by depositing a respective liquid pigment paste, i.e., an ink 5, corresponding to a red, green or blue color filter, into the opening 225 through the nozzles 410 of the single heads 405 while simultaneously translating the inkjet head 400 over the substrate 210, so that the color filters 230 are thereby formed in the openings.

Then, the overcoat 250 of an organic insulating material is formed on the color filters 230 and the light blocking member 220. Subsequently, the common electrode 270 of a transparent conductor, such as ITO and IZO, or the like, is formed on the overcoat 250.

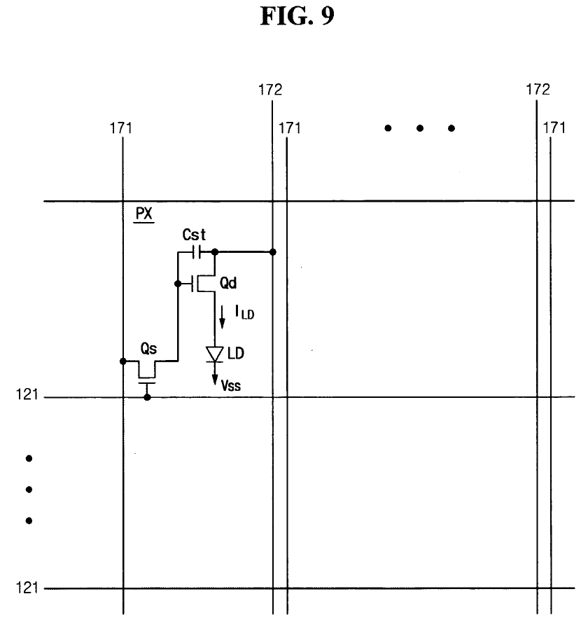

An exemplary embodiment of an OLED display manufactured with an inkjet printing system in accordance with the present invention is described below. FIG. 9 is a schematic circuit diagram of the exemplary OLED display panel. Referring to FIG. 9, the exemplary organic light emitting diode display includes a plurality of signal lines 121, 171, and 172 and a plurality of pixels PX connected to the signal lines and arranged in a generally matrix shape.

The signal lines include a plurality of gates line 121, which respectively transmit gate signals (or scanning signals), a plurality of data lines 171, which respectively transmit data signals, and a plurality of driving voltage lines 172, which respectively transmit driving voltages. The gate lines 121 extend generally in a row direction in FIG. 9 and are substantially parallel with each other. The data lines 171 and the driving voltage lines 172 extend in a generally columnar direction in FIG. 9 and are substantially parallel with each other. Each of the pixels PX includes a switching transistor Qs, an associated driving transistor Qd, a storage capacitor Cst, and an organic light emitting diode (OLED) LD.

The switching transistors Qs each includes a control terminal, an input terminal, and an output terminal. The control terminal is connected to a gate line 121, the input terminal is connected to a data line 171, and the output terminal is connected to the driving transistor Qd. The switching transistor Qs transmits the data signal applied to the data line 171 to the driving transistor Qd in response to the scanning signal applied to the gate line 121.

Each driving transistor Qd also includes a control terminal, an input terminal, and an output terminal. The control terminal is connected to the associated switching transistor Qs, the input terminal is connected to a driving voltage line 172, and the output terminal is connected to the organic light emitting diode LD. The driving transistor Qd conducts an output current ILD, the magnitude of which varies depending on the voltage between the control terminal and the output terminal.

Each of the capacitors Cst is connected between the associated control terminal and the input terminal of the driving transistor Qd. The capacitor Cst charges to the voltage level of the data signal applied to the control terminal of the driving transistor Qd and serves to maintain the same even after the switching transistor Qs is turned off.

Each organic light emitting diode LD includes an anode connected to the output terminal of the associated driving transistor Qd and a cathode connected to the common voltage Vss. The organic light emitting diode LD emits light of different intensities depending on the output current ILD of the driving transistor Qd.

The switching transistors Qs and the driving transistors Qd are n-channel electric field effect transistors (FETs). However, at least one of the switching transistor Qs and the driving transistor Qd may be a p-channel electric FET. The interconnections between the associated transistors Qs and Qd, capacitors Cst and organic light emitting diodes LD can be arranged differently than that of the particular exemplary embodiment illustrated in the figure.

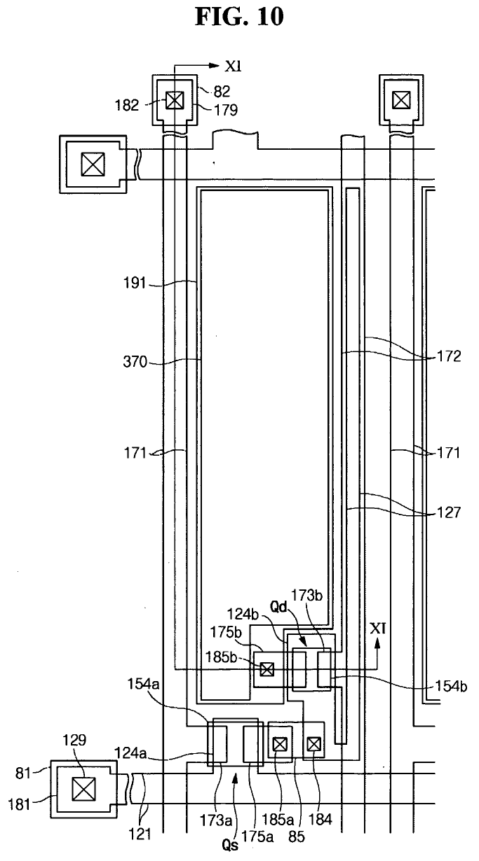

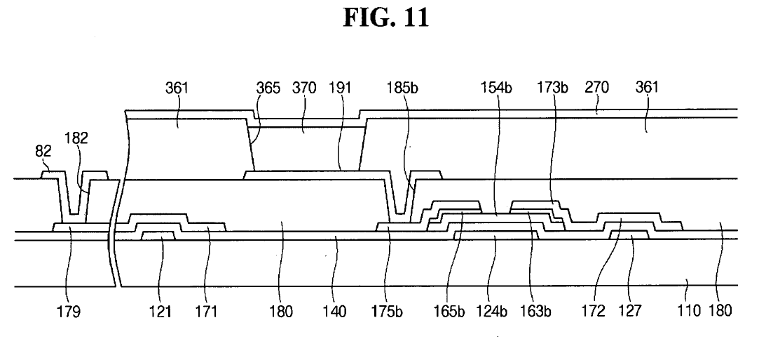

The structure of the exemplary OLED display panel illustrated schematically in FIG. 9 is described below with reference to FIG. 10 and FIG. 11, wherein FIG. 10 is a partial plan view of the exemplary OLED display panel and FIG. 11 is a cross-sectional view of the panel of FIG. 10, as seen along the section lines XI-XI taken therein.

As illustrated in FIGS. 10 and 11, respective pluralities of gate lines 121, each including a first control electrode 124a, and gate conductors, each including a plurality of second control electrodes 124b, are formed on an insulating substrate 110 made of, e.g., a transparent glass, plastic or the like.

The gate lines 121 transmit respective gate signals and extend in a generally horizontal direction in FIG. 10. Each of the gate lines 121 includes an enlarged end portion 129 that is adapted for connection to another layer or an external driving circuit (not illustrated), and the first control electrodes 124a extend generally upward from the gate lines 121. In an embodiment in which a gate driving circuit for generating the gate signals is integrated with the substrate 110 (not illustrated), the gate lines 121 can be extended so as to connect directly to the gate driving circuit.

Each of the second control electrodes 124b are separated from the gate lines 121, and includes a storage electrode 127 that extends downwardly, then slightly to the right, and then upwardly for a relatively longer distance.

The gate conductors 121 and 124b can comprise an aluminum group metal, such as pure aluminum (Al) or an aluminum alloy, a silver group metal, such as pure silver (Ag) or a silver alloy, a copper group metal, such as pure copper (Cu) or a copper alloy, a molybdenum group metal, such as molybdenum (Mo) or a molybdenum alloy, chromium (Cr), tantalum (Ta), titanium (Ti), or the like.

A gate insulating layer 140 made of, e.g., silicon nitride (SiNx), silicon oxide (SiOx), or the like, is formed on the gate conductors 121 and 124b. A plurality of first and second semiconductor islands 154a and 154b made of, e.g., hydrogenated amorphous silicon (a-Si), polysilicon, or the like, is formed on the gate insulating layer 140. The first and second semiconductors 154a and 154b are located over the first and second control electrodes 124a and 124b, respectively.

Respective pluralities of associated pairs of first and second ohmic contacts 163b and 165b are formed on the first and second semiconductors 154a and 154b, respectively. The ohmic contacts 163b and 165b have an island shape, and may be made of a material, such as n+ hydrogenated amorphous silicon, in which an n-type impurity, such as phosphor, is doped at a high concentration, or alternatively, of silicide. The first ohmic contacts are disposed on the first semiconductor 154a in associated pairs, and the second ohmic contacts 163b and 165b are disposed on the second semiconductor 154b in associated pairs.

Respective pluralities of data conductors, including data lines 171, driving voltage lines 172, and first and second output electrodes 175a and 175b are formed on the ohmic contacts 163b and 165b and the gate insulating layer 140.

The data lines 171 respectively transmit a data signal and extend in a generally vertical direction in FIG. 10 so as to cross over the gate lines 121. Each of the data lines 171 includes a plurality of first input electrodes 173a extending toward the first control electrodes 124a and widened end portions 179 adapted for connection to another layer or an external driving circuit (not illustrated).

The driving voltage lines 172 respectively transmit a driving voltage and extend in a generally vertical direction in FIG. 10 so as to cross over the gate lines 121. Each of the driving voltage lines 172 includes a plurality of second input electrodes 173b extending toward the second control electrodes 124b. The driving voltage lines 172 and the storage electrodes 127 overlap and can be connected to each other.

The first and second output electrodes 175a and 175b are separated from each other, from the data lines 171 and from the driving voltage lines 172. The first input electrodes 173a and the first output electrodes 175a are disposed opposite to each other and centered on the first control electrodes 124a, and the second input electrodes 173b and the second output electrodes 175b are disposed opposite to each other and centered on the second control electrodes 124b.

The data conductors 171, 172, 175a, and 175b can comprise, e.g., a fire-resistant metal, such as molybdenum, chromium, tantalum, titanium, or alloys thereof, and may have a multilayer structure that includes a fire-resistant metal layer (not illustrated) and a low-resistance conductive layer (not illustrated).

The ohmic contacts 163b and 165b exist only between the semiconductors 154a and 154b below and the data conductors 171, 172, 175a, and 175b above, and serve to provide a lower contact resistance therebetween. The semiconductors 154a and 154b have portions that are exposed without being covered by the data conductors 171, 172, 175a, and 175b, including a region located between the input electrodes 173a and 173b and the output electrodes 175a and 175b.

The passivation layer 180 is formed on the data conductors 171, 172, 175a, and 175b, the gate insulating layer 140, and the exposed portions of the semiconductors 154a and 154b. The passivation layer 180 can comprise an inorganic insulator, such as silicon nitride or silicon oxide, an organic insulator, an insulating material with a low dielectric constant, or the like. The passivation layer 180 may be formed as a dual-layer structure with a lower inorganic layer and an upper organic layer such that it not only protects the exposed portions of the semiconductors 154 but also has the merits of an organic layer.

A plurality of contact holes 182, 185a, and 185b respectively exposing the end portions 179 of the data lines 171 and the first and second output electrodes 175a and 175b are formed in the passivation layer 180. A plurality of contact holes 181 and 184 respectively exposing the end portions 129 of the gate lines 121 and the second input electrodes 124b are formed in the passivation layer 180 and the gate insulating layer 140.

Respective pluralities of pixel electrodes 191, connecting members 85 and contact assistants 81 and 82 are formed on the passivation layer 180. These members can be made of a transparent conductive material, such as ITO or IZO, or alternatively, of a reflective metal, such as aluminum, silver, or alloys thereof.

The pixel electrodes 191 are physically and electrically connected to the second output electrodes 175b through the contact holes 185b, and the connecting members 85 are respectively connected to the second control electrodes 124b and the first output electrodes 175a through the contact holes 184 and 185a.

The contact assistants 81 and 82 are connected to the end portions 129 of the gate lines 121 and the end portions 179 of the data lines 171 through the contact holes 181 and 182, respectively. The contact assistants 81 and 82 complement the adhesive property of the end portions 129 of the gate lines 121 and the end portions 179 of the data lines 171 to an external device, and also serve to protect these members.

A partitioning wall 361 is formed on the passivation layer 180. The partitioning wall 361 surrounds edges of the pixel electrodes 191 like a berm or a bank, thereby defining upward facing openings 365, and is made of an organic insulator or an inorganic insulator. The partitioning wall 361 may also be made of a photoresist, including a black pigment. In such an embodiment, the partitioning wall 361 thus also serves as a light blocking member, and can be formed by a simple process.

In accordance with one particular exemplary embodiment of the invention, organic light emitting members 370 are formed within the respective openings 365 on the pixel electrodes 191 defined by the partitioning walls 361 by the inkjet printing system of the present invention. Each organic light emitting member 370 is made of an organic material that intrinsically emits light of one of the primary colors, such as red, green, or blue. The organic light emitting diode display displays a desired image as a spatial sum of colored lights of the primary colors emitted by the organic light emitting members 370.

The organic light emitting members 370 may be multi-layered structures that include an auxiliary layer (not illustrated) that improves the light emitting efficiency of the emission layer in addition to an emission layer (not illustrated) that actually emits the light. An electron transport layer (not illustrated) and a hole transport layer (not illustrated) for balancing electrons and holes, an electron injection layer (not illustrated) and a hole injection layer (not illustrated) for enhancing the injection of electrons and holes, or the like, may also be included in the auxiliary layer.

The common electrode 270 is formed on the organic light emitting member 370. The common voltage Vss is applied to the common electrode 270, which is made of a reflective metal, including, e.g., calcium (Ca), barium (Ba), magnesium (Mg), aluminum, silver, or the like, or alternatively, of a transparent, electrically conductive material, such as ITO or IZO.

In an OLED display of the type described above, the first control electrodes 124a connected to the gate lines 121 and the first input electrodes 173a and the first output electrodes 175a connected to the data lines 171, together with the first semiconductors 154a, form the switching thin film transistors (TFTs) Qs, the respective channels of which are formed in the first semiconductors 154a between the first input electrodes 173a and the first output electrodes 175a. The second control electrodes 124b connected to the first output electrodes 175a, the second input electrodes 173b connected to the driving voltage lines 172, and the second output electrodes 175b connected to the pixel electrodes 191, together with the second semiconductors 154b, form the driving thin film transistors (TFTs) Qd, the respective channels of which are formed in the second semiconductors 154b between the second input electrodes 173b and the second output electrodes 175b. The pixel electrodes 191, the organic light emitting members 370, and the common electrodes 270 form the organic light emitting diodes LD. The pixel electrodes 191 may comprise anodes and the common electrode 270 may comprise cathodes, or alternatively, the pixel electrodes 191 may comprise cathodes and the common electrodes 270 may comprise anodes. The storage electrodes 127 and the driving voltage lines 172 overlie each other to form the storage capacitors Cst.

An OLED display such as the exemplary embodiment described above displays images by sending light above and below the substrate 110. Opaque pixel electrodes 191 and a transparent common electrode 270 are used in a “top emission” type of OLED display, which displays images in an upper direction of the substrate 110, and transparent pixel electrodes 191 and an opaque common electrode 270 are used in a “bottom emission” type of OLED display, which displays images in a lower direction of the substrate 110.

As those of skill in the art will appreciate, although the particular exemplary embodiments of OLED display panels described herein are those in which the semiconductors 154a and 154b comprises amorphous silicon, the present invention is not so limited, and can also be applied to OLED display panels in which the semiconductor comprises polysilicon.

Further, since the exemplary inkjet printing systems and the methods for their use in manufacturing flat panel display devices of the present invention include inkjet heads that have a plurality of easily attachable and detachable single heads, in the event that one nozzle of the inkjet head is damaged or becomes dysfunctional, the system can be quickly repaired by replacing only one of the single heads, without the need to replace the entire inkjet head. As a result, the maintenance costs of the inkjet printing system are reduced.

By now, those of skill in this art will appreciate that many modifications, substitutions and variations can be made in and to the inkjet printing systems and the methods for their use in manufacturing LCDs and OLED displays of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. An inkjet printing system, comprising:
a stage on which a substrate is mounted;
an inkjet head operable to deposit ink on the substrate; and,
a transfer device operable to controllably move the inkjet head to selected positions over the substrate,
wherein the inkjet head comprises a frame having a plurality of openings and a plurality of single heads that are attachable to and detachable from respective ones of the openings.

2. The inkjet printing system of claim 1, wherein the frame is formed in a matrix shape.

3. The inkjet printing system of claim 2, wherein at least one nozzle is formed in each single head.

4. The inkjet printing system of claim 1, further comprising a plurality of reserve single heads provided in a column or a row of the openings.

5. The inkjet printing system of claim 1, wherein the substrate comprises a liquid crystal layer or an emission layer.

6. The inkjet printing system of claim 5, wherein the ink is adapted to form a color filter or an organic light emitting member on the substrate.

7. The inkjet printing system of claim 6, wherein a partitioning wall member for enclosing the deposited ink is formed on the substrate.

8. The inkjet printing system of claim 7, wherein the partitioning wall member comprises a light blocking member or a partitioning wall.

9. A display manufactured using the inkjet printing system of claim 1.

10. A method for manufacturing a display device, the method comprising:
positioning an inkjet head over a substrate, the inkjet head including a frame having a plurality of openings and a plurality of single heads that are attachable to and detachable from respective ones of the openings;
depositing ink on the substrate through a nozzle of each single head of the inkjet head;
detecting a dysfunctional nozzle in one of the single heads, and,
replacing the single head with the dysfunctional nozzle.

11. A method for manufacturing a display device, the method comprising:
positioning an inkjet head over a substrate, the inkjet head including a frame having a plurality of openings and respective pluralities of single heads and reserve single heads that are attachable to and detachable from respective ones of the openings;
depositing ink on the substrate through a nozzle of each single head of the inkjet head;
detecting a dysfunctional nozzle in one of the single heads;
stopping operation of the single head with the dysfunctional nozzle; and,
operating a selected one of the reserve single heads in the place of the single head with the dysfunctional nozzle.

12. The method of claim 10, wherein the frame is formed in a matrix shape.

13. The method of claim 12, wherein at least one nozzle is formed in each single head.

14. The method of claim 10, wherein the plurality of reserve single heads are disposed in a column or a row of the plurality of openings.

15. The method of claim 10, wherein the substrate comprises a liquid crystal layer or an emission layer.

16. The method of claim 15, wherein the ink is adapted to form a color filter or an organic light emitting member on the substrate.

17. The method of claim 16, wherein the ink is deposited in openings of a partitioning wall member of the substrate.

18. The method of claim 17, wherein the partitioning wall member comprises a light blocking member or a partitioning wall.

19. A display manufactured in accordance with the method of claim 10.

20. A display manufactured in accordance with the method of claim 11.
